(19) United States
(12) Patent Application Publication
(10) Pub. No.: US 2014/0025983 A1
(43) Pub. Date: Jan. 23, 2014

(54) INFORMATION PROCESSING APPARATUS AND METHOD FOR GENERATING PSEUDO FAILURE

(71) Applicant: FUJITSU LIMITED, Kawasaki-shi (JP)

(72) Inventors: Noriko USUI, Shinagawa (JP); Katsuyuki SUZUKI, Yokohama (JP)

(73) Assignee: FUJITSU LIMITED, Kawasaki-shi (JP)

(21) Appl. No.: 14/032,232

(22) Filed: Sep. 20, 2013

Related U.S. Application Data
(63) Continuation of application No. PCT/JP2011/058713, filed on Apr. 6, 2011.

(51) Int. Cl. G06F 11/263; G06F 11/07

(52) U.S. Cl. CPC G06F 11/263; G06F 11/0793
USPC 714/2; 714/33

(57) ABSTRACT

A controller that obtains data from an object device in obedience to an obtaining request from the processor includes an error setter that sets, when a pseudo failure mode that spuriously generates a failure is active, an error associated with a failure type of a pseudo failure to be generated in the data obtained from the object device in obedience to the obtaining request; and an error processor that notifies, when detecting an error in the data under a state where the pseudo failure mode is active, the processor of the failure response corresponding to the failure type associated with the detected error.

### CROSS-REFERENCE TO RELATED APPLICATION

This application is a continuation application of International Application No. PCT/JP2011/058713, filed on Apr. 6, 2011, and designated the U.S., the entire contents of which are incorporated herein by reference.

### FIELD

The embodiment discussed herein is an information processing apparatus and a method for generating a pseudo failure.

### BACKGROUND

In the cases where a failure occurs in a hardware device such as an Input Output (IO) device used in an information processing apparatus such as a server and a Personal Computer (PC), this failure may trigger various problems such as system hang-up.

In the event of occurrence of such a problem, the cause for the problem is specified and the problem is to be dealt with through the investigation of the problem.

One way of the investigation of a problem that has occurred is accomplished by a reproduction test that reproduces a failure that is assumed to be a cause for the problem on the hardware. This reproduction test is carried out by, for example, spuriously generating a failure (pseudo failure) on a hardware device such as an IO device connected to a host device such as a processor.

A reproduction test is sometimes carried out when there is a difficulty in using environment where a problem has actually occurred, such as, in the cases where the problem has occurred in client environment, or when the investigation undergoes in the hardware where the problem has not actually occurred.

Also in the cases where a recovery operation made on a device driver to deal with a failure having occurred in a hardware device such as an IO device is to be verified, a pseudo failure is generated on an IO device connected to the host device and the investigation of the problem caused by the failure is sometimes carried out on the IO device as the reproduction test performs.

The following methods (i) and (ii) disclose examples of a technique that generates a pseudo failure in an IO device such as a Hard Disk Drive (HDD) for the above reproduction test or the confirmation test of a recovery operation.

(i) If the firmware of an IO device recognizes a special condition, a pseudo failure is generated. Examples of the special condition are that the firmware of the IO device is changed to setting for a pseudo failure, and, if the IO device is compatible with the standards of Small Computer System Interface (SCSI), the IO device is shifted to a failure operating mode by a Mode Select command.

(ii) A special pattern is attached to the data portion (main data) included in data forwarded from, for example, an IO device, and a pseudo failure defined beforehand in association with the attached pattern is recognized and is then generated.
[Patent Literature 1] Japanese Laid-open Patent Publication No. 2000-48478
[Patent Literature 2] Japanese Laid-open Patent Publication No. 9-204317

However, the above methods (i) and (ii) have the following disadvantages in generation of a pseudo failure in, for example, an IO device.

The above method (i) uses special firmware to generate a pseudo failure. However, firmware used in normal operation (practical operation) has difficulty in achieving a state of the presence of a pseudo failure.

For the above, in generation of a pseudo failure, firmware for generating a pseudo failure is installed into the IO device in place of the firmware for practical firmware, which takes additional time before the reproducing test starts.

Furthermore, the above method can set a type of pseudo failure to be generated and always generate the same failure, but has difficulty in carrying out a reproduction test that assumes occurring of multiple types of failure.

The other method (ii) attaches a special pattern to generate a pseudo failure on a data portion and, for this purpose, modified practical data is to be used in practical operation. This brings a problem of difficulty in generating a pseudo failure using the practical data.

The method (ii) prepares a function to recognize a pseudo failure associated with an attached pattern. The recognition sometimes generates overhead, which consequently takes time to accomplish the test.

### SUMMARY

According to an aspect of the embodiment, an information processing apparatus comprising a processor and a controller that obtains data from an object device in obedience to an obtaining request from the processor, the controller including: an error setter that sets, when a pseudo failure mode that spuriously generates a failure is active, an error associated with a failure type of a pseudo failure to be generated in the data obtained from the object device in obedience to the obtaining request; and an error processor that notifies, when detecting an error in the data under a state where the pseudo failure mode is active, the processor of the failure response corresponding to the failure type associated with the detected error.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram schematically illustrating an example of the configuration of an information processing apparatus according to a first embodiment;

FIG. 2 is a flow diagram denoting an example of a succession of procedural steps of setting a pseudo failure by a controller of the first embodiment;

FIG. 3 is a flow diagram denoting an example of a succession of procedural steps of generating a pseudo failure by a controller of the first embodiment;

FIG. 4 is a block diagram illustrating an example of a detailed configuration of a controller of the first embodiment;

FIG. 5 is a diagram illustrating an example of failure type data used in a controller of the first embodiment;

FIG. 6 is a diagram illustrating an example of failure setting data used in a controller of the first embodiment;

FIG. 7A is a table denoting an example of data to be processed during detection of the error bit position by an error detector of the first embodiment;

FIG. 7B is a diagram denoting a result of ECC data check by the error detector on the error embedded data;

FIG. 8 is a diagram illustrating an example of a detailed operation of setting a pseudo failure by a controller of the first embodiment;

FIG. 9 is a diagram illustrating an example of a detailed operation of generating a pseudo failure by a controller of the first embodiment; and

FIG. 10 is a flow diagram denoting an example of a succession of detailed procedural steps of generating a pseudo failure by a controller of the first embodiment.

### DESCRIPTION OF EMBODIMENTS

Hereinafter, a first embodiment will now be described with reference to the accompanying drawings.

### (1) First Embodiment

### (1-1) Example of Entire Configuration

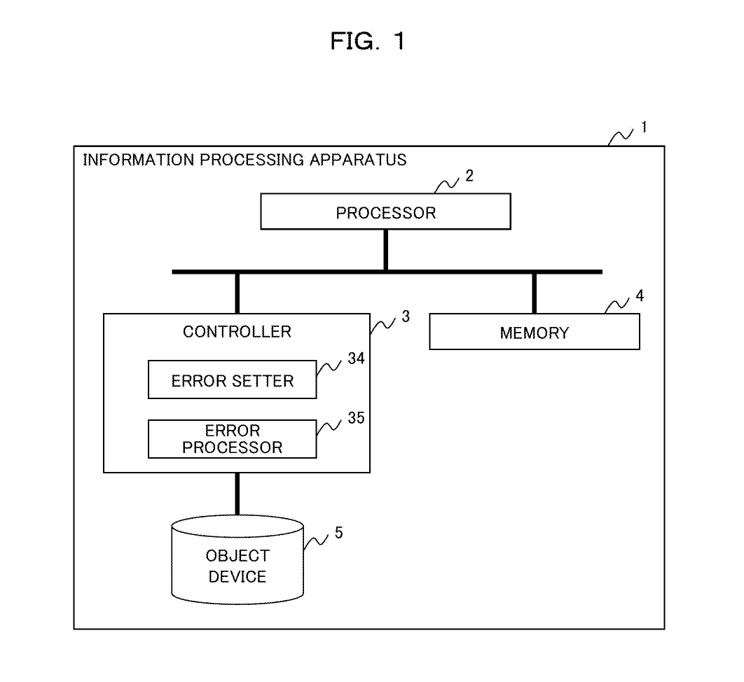

FIG. 1 is a block diagram schematically illustrating an information processing apparatus 1 according to a first embodiment.

As illustrated in FIG. 1, the information processing apparatus 1 includes a processor 2, a controller 3, a memory 4, and an object device 5.

The processor 2 carries out various controls and calculations, and achieves various functions by executing programs stored in a storage device functioning as the object device 5 or in a non-illustrated Read Only Memory (ROM). An example of the processor 2 is at least one processor, such as a Central Processing Unit (CPU) or a Micro Processing Unit (MPU).

The memory 4 is a memory region to temporarily store various pieces of data and programs therein. When the processor 2 is to execute a program, data and the program are temporarily stored in and expanded on the memory 4 for use. An example of the memory 4 is a volatile memory such as a Random Access Memory (RAM).

The object device 5 is an IO device which is exemplified by a magnetic disk device such as a HDD, a semiconductor device such as a Solid State Drive (SSD), an optical driver that reads data stored in an optical disk, or a card reader that reads data stored in a flash memory, or a tape drive. Namely, the object device 5 is a hardware device that stores therein various data pieces and programs. The object device 5 is connected to the controller 3 and outputs data and programs stored therein under control of the controller 3.

Hereinafter, the objet device 5 is also referred to as the IO device 5.

The controller 3 is connected to the processor 2 and object device 5, and controls the object device 5 in obedience to requests from the processor 2 serving as hosts. For example, the controller 3 obtains data from the object device 5 in obedience to an obtaining request issued by the processor 2, which functions as the host device. An example of the controller 3 is an IO controller.

Specifically, upon receipt of a request to obtain data stored in the IO device 5 from the processor 2, the controller 3 obtains (reads) data assigned by the request from the object device 5 and outputs the read data to the processor 2. Then, the controller 3 checks whether the data (hereinafter called original data) obtained from the IO device 5 in response to the obtaining request has an error, and if an error is detected and is correctable, the controller 3 corrects the error.

The controller 3 of the first embodiment has a function of generating a pseudo failure of the hardware in obedience to an obtaining request to obtain data stored in the IO device 5 from the processor 2 and notifying the processor 2 of the generated pseudo failure in response to the request.

For this purpose, the controller 3 of the first embodiment includes an error setter 34 and an error processor 35.

The error setter 34 sets, in the cases where a pseudo failure mode that spuriously generates a failure is active, an error corresponding to the failure type of pseudo failure to be generated in the data obtained form the IO device 5 in obedience to the obtaining request from the processor 2.

Here, the pseudo failure mode is one of the operation modes of the controller 3 and spuriously generates a failure under a state where firmware used in practical operation is kept to be active. The pseudo failure mode is activated and cancelled by a non-illustrated external host device, such as a service processor, that manages the information processing apparatus 1.

A failure type is information indicating at least one failure that the controller 3 generates to be a pseudo failure, and an error corresponding to the failure type is set in data obtained in obedience to an obtaining request such that the error check on the data detects the error as will be described below. A failure type and an error corresponding to the failure type will be detailed below.

The error processor 35 notifies, if detecting an error in the data when the pseudo failure mode is active, the processor of a failure response in regard of a failure type corresponding to the detected error. A failure response is a response to a pseudo failure set by the error setter 34 and is to be notified to the processor 2, assuming that a failure spuriously occurs in the IO device 5.

Specifically, the error processor 35 carries out error check, in the same manner as the normal operation (practical operation) of the information processing apparatus 1, on data (hereinafter also referred to as error embedded data) obtained by setting an error in the original data by the error setter 34.

In the event of detection of the error set by the error setter 34 through the error check, the error processor 35 receives information related to the detected error from the controller 3.

Then, the error processor 35 generates a failure response to the failure type corresponding to the detected error and notifies processor 2 of the generated failure response.

Namely, if the error processor 35 detects an error in the error embedded data in which the error setter 34 has intentionally set a correctable error (e.g. a 1-bit error) through error check, the error processor 35 does not correct the error but does notify the processor 2 of a failure response related to the failure type corresponding to the detected error.

Upon input of the failure response to the obtaining request, output to the controller 3, from the error processor 35, the processor 2 comes to be able to carry out a test, such as the above reproduction test or confirmation of the error recovery of a device driver, using the input failure response.

### (1-2) Example of Operation of the Controller

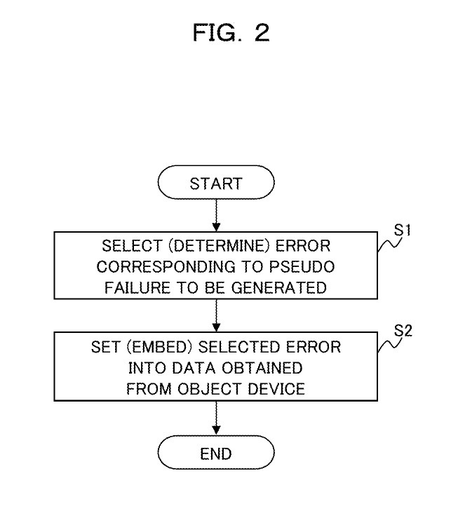

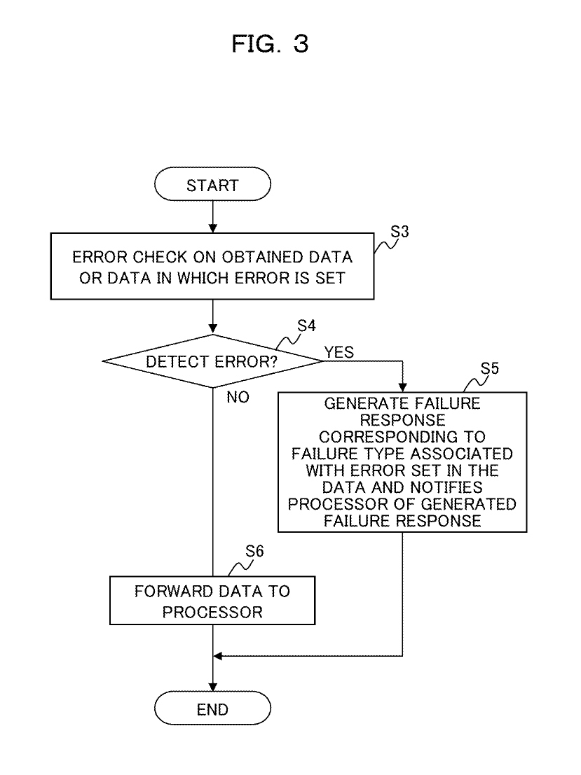

Description will now be made in relation to an example of operation by the controller 3 included in the above information processing apparatus 1 of the first embodiment with reference to FIGS. 2 and 3.

FIG. 2 is a flow diagram depicting a succession of procedural steps of setting a pseudo failure by the controller 3 of the first embodiment; and FIG. 3 is a flow diagram depicting a succession of procedural steps of generating a pseudo failure by the controller 3.

As illustrated in FIG. 2, the controller 3 at first selects an error corresponding to the failure type, i.e., an error corresponding to a pseudo failure to be generated (step S1).

Then, an error selected by the error setter 34 is set in the data obtained from the object device 5 in obedience to the obtaining request (step S2). Specifically, the error setter 34 embeds the selected error into the original data.

Subsequently, as illustrated in FIG. 3, the controller 3 carries out error check on data (i.e., original data) obtained from the object device 5 in obedience to the obtaining request from the processor 2 or on error embedded data in which an error is set (step S3), so that the presence or the absence of an error is determined (step S4).

If an error is detected (Yes route in step S4), the error processor 35 generates a failure response related to the failure type corresponding to the error set in the data and notifies the processor 2 of the generated failure response (step S5). Thereby, the procedures of setting and generating a pseudo failure by the controller 3 finish.

On the other hand, if no error is detected (No route in step S4), the controller 3 forwards the original data to the processor 2 (step S6) and the procedures finish. In other words, when the error check by the controller 3 does not detect an error, the controller 3 forwards the data obtained from the object device 5 in obedience to the obtaining request from the processor 2 to the processor 2 in accordance with the normal operation of the information processing apparatus 1. Even if an error is detected in step S4, the controller 3 not generating a pseudo failure, that is, when the pseudo failure mode is not active, may correct the error detected by the error processor 35 and may further forward the data whose error is connected to the processor 2 in step S6.

In the controller 3 according to an example of the first embodiment, when an error set by the error setter 34 is detected through the error check on the data under the state where the pseudo failure mode is active, the error processor 35 notifies the processor 2 of the failure response related to the failure type corresponding to the detected error.

In other words, the presence of the error setter 34 that sets an error corresponding to the failure type to be generated in the original data allows the controller 3 to detect the error set in the original data using the function of error check that the controller 3 has. Furthermore, the presence of the error processor 35 that notifies, when the pseudo failure mode is active, the processor 2 of a failure response related to the failure type corresponding to the detected error allows the controller 3 to spuriously generate such a failure response that indicates a failure occurred in the IO device 5.

As the above, since the function of error check that the controller 3 has can be applied to generation of a pseudo failure, the presence of the error setter 34 and the error processor 35 reduces procedural steps of generating a pseudo failure and consequently, the information processing apparatus 1 can be easily tested even during normal operation thereof. Namely, a test accompanying generation of a pseudo failure can be easily carried out on the information processing apparatus 1 that is put into practical operation.

The controller 3 obtains data to be used in practical operation from the IO device 5 in obedience to an obtaining request. Accordingly, when no error is detected in the data through error check performed by the controller 3 or when the controller 3 is not generating a pseudo failure, in other words, when an error is detected while the pseudo failure mode is not active, the controller 3 is allowed to carry out processing of practical operation. Namely, when no error is detected in the data through the error check, the controller 3 can output the obtained original data to the processor 2 along the practical operation. In the cases where an error different from the error set by the error setter 34 is detected, the controller 3 can notify the processor 2 of occurrence of the error or can output, if the controller 3 has a function of correcting an error, the data underwent error correction to the processor 2 along the practical operation. Furthermore, the controller 3 can notify the processor 2 of a pseudo failure simply by switching between activating and cancelling the pseudo failure mode under a state where the firmware used in the practical operation is functioning.

Consequently, since it is possible to conduct a test carried out in the information processing apparatus 1 being in practical operation, reducing affects in the practical operation when a pseudo failure is generated and using data in the practical operation, the accuracy of the test can be enhanced.

(1-3) Example of the Detailed Configuration of the Controller:

Next, an example of the detailed configuration of the controller 3 will now be described.

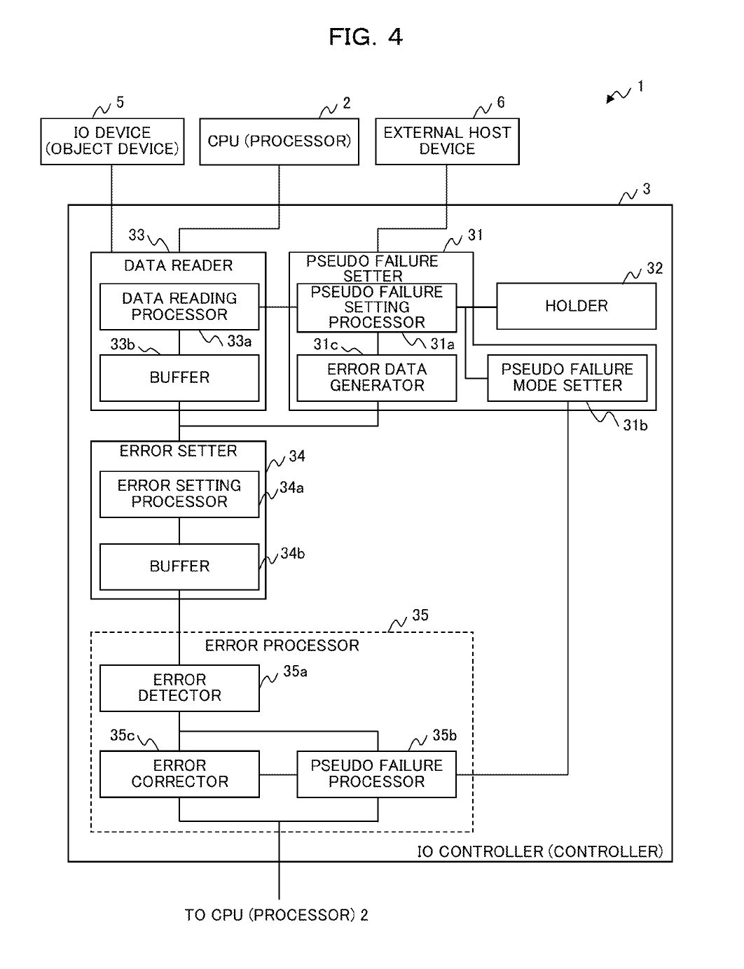

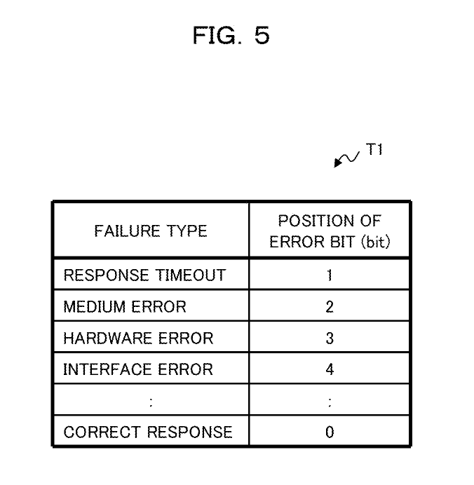

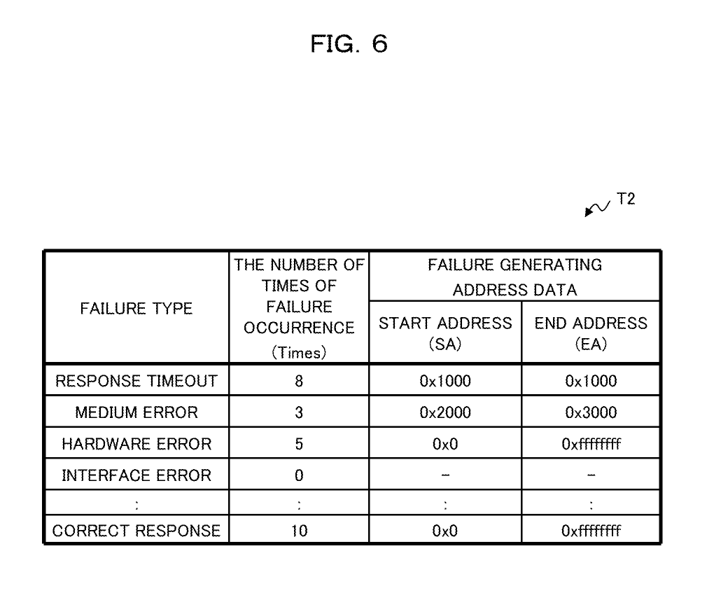

FIG. 4 is a diagram illustrating an example of the detailed configuration of the controller 3 of the first embodiment. FIG. 5 is a diagram illustrating an example of failure type data used in the controller 3 of the first embodiment, and FIG. 6 is a diagram illustrating an example of failure setting data used in the controller 3.

As illustrated in FIG. 4, the information processing apparatus 1 includes an external host device 6.

In addition to the error setter 34 and the error processor 35 that appear in FIG. 1, the controller 3 can further include a pseudo failure setter 31, a holder 32, and a data reader 33.

The external host device (setter) 6 causes the controller 3 to activate or cancel the pseudo failure mode, and specifically issues a pseudo failure mode request that activates the pseudo failure mode and a pseudo failure mode cancel request that cancels the pseudo failure mode to the controller 3.

The external host device 6 further outputs failure setting data related to the condition to generate error data that will be detailed below to the controller 3.

An example of the external host device 6 is a service processor that, for example, manages the information processing apparatus 1.

The holder 32 holds failure setting data related to the condition to be used in generation of error data in the pseudo failure setter 31, and is exemplified by a volatile memory such as a RAM.

The holder 32 further stores therein the failure setting data, in the form of a table (failure setting table T2) illustrated in FIG. 6, input from the external host device 6 through the pseudo failure setter 31 and holds the table.

The failure setting data includes at least one of the number of times of failure occurrence and failure generating address data. The number of times of failure occurrence and/or failure generating address data are associated with each failure type to be generated.

The failure setting data and the error data will be detailed below.

Upon receipt of a pseudo failure mode request from the external host device 6, the pseudo failure setter 31 carries out a setting process to generate a pseudo failure. Furthermore, upon receipt of an obtaining request from the processor 2, the pseudo failure setter 31 generates error data corresponding to the failure type to be generated on the basis of data set through the setting process and outputs the generated error data to the error setter 34.

The pseudo failure setter 31 includes a pseudo failure setting processor 31a, a pseudo failure mode setter 31b, and an error data generator 31c.

Upon receipt of a pseudo failure mode request including failure setting data from the external host device 6, the pseudo failure setting processor 31a stores the received failure setting data into the holder 32, and causes the pseudo failure mode setter 31b to activate the pseudo failure mode.

The pseudo failure mode setter 31b manages activating and cancelling the pseudo failure mode serving as an operation mode of the controller 3, and is exemplified by a register.

As discussed above, the pseudo failure mode is one of the operation modes of the controller 3 and spuriously generates a failure under a state where firmware used in practical operation is kept to functioning. Namely, the pseudo failure mode carries out predetermined error setting and detecting on data under a state where the controller 3 keeps processing related to the obtaining request from the processor 2 during the practical operation, so that a failure response of a pseudo failure, the response being to be notified to the processor 2, is generated.

Activating and cancelling of the pseudo failure mode may be switched with, for example, a Dual In-line Package (DIP) switch on the board mounting the processor 2 thereon.

In response to the pseudo failure mode request from the external host device 6, the pseudo failure setting processor 31a sets, for example, a flag “1” representing “on” in the pseudo failure mode setter 31b. This causes the pseudo failure mode setter 31b to activate the pseudo failure mode.

The pseudo failure setting processor 31a cancels the pseudo failure mode when the number of times of generating error data corresponding to the failure type spuriously generated reaches the corresponding number of times of failure occurrence, the number being set in the failure setting data or when the external host device 6 inputs a pseudo failure mode cancel request into the pseudo failure setting processor 31a. Specifically, the pseudo failure setting processor 31a sets, for example, a flag “0” representing “off” in the pseudo failure mode setter 31b to finish the pseudo failure mode. This causes the pseudo failure mode setter 31b to cancel the pseudo failure mode.

Upon receipt of, from the data reader 33, an address of data to be obtained in obedience to an obtaining request that the processor 2 issues, that is, an address of the IO device 5, the pseudo failure setting processor 31a refers to the pseudo failure mode setter 31b to confirm whether the pseudo failure mode is on.

When the pseudo failure mode is off, the pseudo failure setting processor 31a finishes the procedure. Consequently, the controller 3 functions in the normal operation mode that causes the controller 3 to practically operate such as controlling obtaining data from IO device 5 in obedience to an obtaining request from the processor 2 along the practical operation.

On the other hand, when the pseudo failure mode is on, the pseudo failure setting processor 31a turns into the pseudo failure mode and selects the failure type to be generated, using the failure setting data held in the holder 32 on the basis of the address of the IO device 5 input from the data reader 33.

The manner of selecting a failure type by the pseudo failure setting processor 31a will be detailed below.

Besides, the pseudo failure setting processor 31a sets error data corresponding to the selected failure type on the basis of the failure type data depicted in FIG. 5 into the error data generator 31c.

The error data generator 31c temporarily holds error data that the pseudo failure setting processor 31a sets therein, and outputs the error data stored therein to the error setter 34. An example of the error data generator 31c is a register.

Next, description will now be made in relation to failure type data.

Failure type data includes at least one failure type representing a type of failure to be generated as a pseudo failure and an error bit position associated with each failure type.

As depicted in FIG. 5, examples of the failure type of a pseudo failure to be generated are: a failure that a response is not notified to the processor 2 and that is exemplified by “response timeout” representing occurrence of response time out in the IO device 5 to a request from the controller 3 to the IO device 5; “medium error” that represents, if the IO device 5 is an optical drive device and a card reader, occurrence of an error in a medium, such as an optical disk and a flash memory from which data is to be read; “hardware error” representing occurrence of a hardware failure in the IO device 5; and “interface error” representing occurrence of an error at an interface of the IO device 5 with the controller 3.

The failure types are not limited to the examples of FIG. 5, but may be “data error” representing occurrence of an error in data obtained from the IO device 5 or a more detailed hardware error.

As illustrated in FIG. 5, “correct response” representing that no failure occurs in the IO device 5 and therefore the IO device 5 normally responds to a request from the controller 3 may be defined as one of the failure types.

An error bit position represents the position where an error bit is detected through the error check of data will be detailed below and is associated with each failure type. The error data is in the form of an error pattern (error bit form) representing the error bit position corresponding to a failure type and is exemplified by a pattern having the same bit number as the original data but is different only in the value of the bit at the error bit position from the original data.

Specifically, the pseudo failure setting processor 31a obtains the error bit position associated with the failure type to be generated as a pseudo failure on the basis of the above failure type data. The pseudo failure setting processor 31a instructs to the error data generator 31c to invert the bit at the error bit position obtained and thereby generates an error pattern representing the same error bit position, i.e., the error data.

Assuming that the error data generator 31c is a register, the value “0” is set in all the bits in the register being in the initial state. Under this state, the pseudo failure setting processor 31a sets “1” into the bit in the register corresponding to the obtained error bit position. The error pattern is generated in this manner, i.e., the pseudo failure setting processor 31a causing the error data generator 31c to set “1” into the bit at a position corresponding to the error bit position.

As depicted in the example of FIG. 5, when the pseudo failure setting processor 31a selects “response timeout” as the failure type, the pseudo failure setting processor 31a obtains the bit “1” as the error bit position corresponding to the failure type on the basis of the failure type data. Then, the pseudo failure setting processor 31a sets the value “1” in the bit “1” of the error data generator 31c and the remaining bits, i.e. bits “0”, and bit “2” through “the maximum bit of the original data obtained from the object device 5” all have initial value “0”. This generates an error pattern in which only the value at the bit “1” is “1”. Hereinafter, the maximum bit of the original data in which an error is to be set is referred to as bit n (where, n is an integer of 1 or more).

Assuming that the pseudo failure setting processor 31a selects “medium error” as the failure type, since the corresponding error bit position is bit “2”, an error pattern in which only the value at the bit “2” is “1” is generated. When the pseudo failure setting processor 31a selects “hardware error” as the failure type, the error bit position is “3” so that an error pattern in which only the value at the bit “3” is “1” is generated. When the pseudo failure setting processor 31a selects “interface error” as the failure type, the error bit position is “4” so that an error pattern in which only the value at the bit “4” is “1” is generated.

Under a state where “normal response” is defined as a failure type, when the pseudo failure setting processor 31a selects “normal response” for the failure type, the error bit position is “0” so that an error pattern in which only the value at the bit “0” is “1” is generated.

The above failure type data may be set in the form of a table (failure type table T1) in the firmware of the controller 3 by the external host device 6 beforehand. Alternatively, when the controller 3 is equipped with a volatile memory such as a RAM or a non-volatile writable-readable memory such as a flash memory, the failure type data may be stored in the RAM or the flash memory, and may be changeable by the external host device 6 or the firmware of the controller 3. The failure type data may be output to the pseudo failure setter 31 by the external host device 6 and stored into the holder 32 by the pseudo failure setting processor 31a.

The data reader 33 obtains data from the IO device 5 in obedience to the obtaining request from the processor 2, and outputs the obtained data to the error setter 34. The data reader 33 includes a data reading processor 33a and a buffer 33b.

The data reader 33 outputs, upon receipt of the obtaining request from the processor 2, the address of the data to be obtained in obedience to the obtaining request, that is, the address of the IO device 5, to the pseudo failure setter 31 (pseudo failure setting processor 31a).

Then the data reading processor 33a accesses the address of the data to be obtained in obedience to the obtaining request, obtains the original data, and outputs the obtained original data to the buffer 33b.

Here, when the information processing apparatus 1 is to carry out a reproduction test described above, the data that the data reading processor 33a reads is data to be read by software such as an application that is to actually operate.

The data reading processor 33a obtains data from the IO device 5 in units of predetermined blocks. The block preferably has a size more than the register size of the error data generator 31c, which is the number of bits of a single error pattern. Namely, the pseudo failure setting processor 31a generates an error pattern having a size (the number of bits) not more than the size of the block.

The buffer 33b temporarily holds data that the data reading processor 33a obtains from the IO device 5, and outputs the obtained data to the error setter 34. An example of the buffer 33b is a volatile memory such as a RAM.

The error setter 34 includes an error setting processor 34a and a buffer 34b.

The error setting processor 34a generates error embedded data by setting an error corresponding to the failure type to be generated in the original data input from the buffer 33b of the data reader 33 on the basis of the error pattern input by the error data generator 31c of the pseudo failure setter 31. The error setting processor 34a further outputs the generated error embedded data to the buffer 34b.

Specifically, the error setting processor 34a carries out, for example, bitwise exclusive disjunction on the input original data and the error pattern. Consequently, the error setting processor 34a inverts a bit of the original data at a bit position corresponding to the bit set to be “1” in the error pattern.

An example of the error setting processor 34a is an Exclusive OR (XOR) circuit.

The buffer 34b temporarily holds error embedded data generated by the error setting processor 34a and outputs the holding error embedded data to the error processor 35. An example of the buffer 34b is a volatile memory such as a RAM.

If the pseudo failure setter 31 does not generate an error pattern, the error setting processor 34a outputs the original data to the buffer 34b.

When an error pattern is not generated, only the original data from the buffer 33b is input into error setting processor 34a, no data from the error data generator 31c or data all bit of which are set to be “0” is input into the error setting processor 34a. In either case, the error setting processor 34a outputs, as the result of the external disjunction, the data having the same pattern as that of the original data to the buffer 34b.

In other words, when an error pattern is not generated because the controller 3 does not generate a pseudo failure, the error setter 34 obtains the data related to the obtaining request of the processor 2 from the IO device 5 along the practical operation and outputs the obtained data to the downstream error processor 35.

In addition to the cases where the pseudo failure mode is off, an error pattern is not generated in the cases where the pseudo failure mode is on but data obtained from the IO device 5 in obedience to the processing request (obtaining request) does not satisfy the condition defined in the failure setting data to be detailed below.

As illustrated in FIG. 4, the error processor 35 includes an error detector 35a, a pseudo failure processor 35b, and an error corrector 35c.

The error detector 35a carries out error check to determine whether the original data input from the buffer 34b of the error setter 34 or the error embedded data has an error, and detects, if determining the presence of an error, the error bit position. Hereinafter, the original data or the error embedded data is simply referred to as “input data”.

The manner of error check is exemplified by data check using an error detection/correction code called Error Correcting Code (ECC). In this example, the error detector 35a detects the error bit position using an ECC. The following description assumes that the error detector 35a carries out error check using an ECC.

Specifically, when an error is detected in the input data as a result of the error check, the error detector 35a notifies the error bit position of the detected error to the pseudo failure processor 35b.

In either case of detecting an error in the error check and detecting no error in the error check, the error detector 35a outputs the input data to the downstream error corrector 35c.

The manner of detecting the error bit position by the error detector 35a will be detailed below.

When the data input from the error detector 35a has no error, the error corrector 35c outputs the input data to the processor 2. On the other hand, when the input data has an error, the error corrector 35c corrects a correctable error among one or more errors detected by the error detector 35a and outputs (forwards) the corrected data to the processor 2.

Upon receipt of an output ceasing instruction from the pseudo failure processor 35b, the error corrector 35c stops outputting the data input from the error detector 35a to the processor 2. The stopping of data output can be achieved through, for example, masking the response header used to send the input data by the error corrector 35c. Alternatively, any known manner may be applied to the stopping. For example, a ceasing function to stop downstream outputting data may be disposed at the error detector 35a, at between the error detector 35a and the error corrector 35c, and at the error corrector 35c, and the pseudo failure processor 35b may issue the output ceasing instruction to the stopping function so that the data outputting is stopped.

When the error detector 35a detects an error in the input data under a sate where the pseudo failure mode is active, the pseudo failure processor 35b does not allow the error corrector 35c to correct the detected error and notifies the processor 2 of a failure response associated with the failure type corresponding to the detected error.

Specifically, in the cases where the error check performed by the error detector 35a detects an error bit position, the pseudo failure processor 35b obtains the detected error bit position from the error detector 35a. Then the pseudo failure processor 35b confirms, by referring to the pseudo failure mode setter 31b, whether the pseudo failure mode is on.

When the pseudo failure mode is off, the pseudo failure processor 35b terminates the procedure.

In contrast, when the pseudo failure mode is on, the pseudo failure processor 35b outputs an output ceasing instruction to, for example, the error corrector 35c. Furthermore, the pseudo failure processor 35b obtains the failure type corresponding to the obtained error bit position on the basis of the failure type data, generates a failure response related to the obtained failure type, and notifies the processor 2 of the generated failure response.

When the pseudo failure mode is off, the pseudo failure processor 35b may omit outputting an output ceasing instruction to, for example, error corrector 35c, and the error corrector 35c may correct the error in the error embedded data similarly to the practical operation and output the corrected data to the processor 2.

The pseudo failure processor 35b can be configured not to generate, when the obtained failure type is “response timeout”, a failure response associated with the failure type and also not to notify a failure response to the processor 2.

In the above controller 3 of the first embodiment, when the pseudo failure mode is off, the data obtained from the IO device 5 in obedience of an obtaining request is output to the processor 2, which has issued the obtaining request. In contrast, when the pseudo failure mode is on, the data obtained from the IO device 5 in obedience of an obtaining request is prevented from being output to the processor 2 so that a state of occurring a failure in IO device 5 spuriously arises.

Upon receipt of, from the pseudo failure processor 35b, a failure response to the obtaining request that the processor 2 has output to the controller 3, the processor 2 comes to be able to perform the above reproduction test or confirmation of error recovery of a device driver using the input failure response.

As described above, the controller 3 obtains data from the IO device 5 in obedience to the obtaining request from the processor 2 the same as practical operation, and upon receipt of a pseudo failure mode request from the external host device 6, the controller 3 can start pseudo failure setting and pseudo failure generating according to the first embodiment.

(1-3-1) Example of Setting Failure Setting Data:

Next, description will now be made in relation to the failure setting data (failure setting table T2) held by the holder 32 with reference to FIG. 6.

As described above, the failure setting data, which is related to the condition to generate error data in the pseudo failure setter 31, may include at least one of the number of times of failure occurrence and the failure generating address data, which serve as parameters. The number of times of failure occurrence and the failure generating address data are associated with each failure type to be generated.

The number of times of failure occurrence (represented by “Times” in the table) represents the number of times of generating a pseudo failure corresponding to each failure type. The pseudo failure setting processor 31a generates error data corresponding to a failure type to be generated until the number of times of generating error data corresponding to the failure type reaches the corresponding number of times of failure occurrence. This means that the number of times of failure occurrence is one of a condition to generate a pseudo failure of the corresponding failure type.

In the example of FIG. 6, the values “8”, “3”, “5”, “0”, and “10” are set for the respective numbers of times of failure occurrence of “response timeout”, “medium error”, “hardware error”, “interface error” and “correct response”, respectively. As an example in the FIG. 6, in regard of a failure type set “0” for the number of times of failure occurrence, the pseudo failure setting processor 31a does not generate a pseudo failure of the failure type in question.

The pseudo failure setter 31 preferably includes a function of counting the number of setting error data corresponding to each individual failure type since the pseudo failure mode has been activated. Otherwise, the pseudo failure setter 31 may decrement, each time error data is set since the pseudo failure mode has been activated, the number of times of failure occurrence of each failure type corresponding to the failure type in the failure setting data stored in the holder 32.

As described above, when the condition to generate error data includes the number of times of failure occurrence, a failure type for which the number of times of generating error data has not reached the number of times of failure occurrence associated with the failure type in question since the pseudo failure mode has been activated has a possibility of being selected as the failure type to be spuriously generated.

In the first embodiment, the pseudo failure setter 31 selects a failure type that satisfies both conditions of the number of times of failure occurrence and the failure generating address data as the failure type to be generated. In the cases where the failure setting data does not include failure generating address data and also multiple failure types satisfy the above conditions, the pseudo failure setter 31 may select a failure type that has the largest or smallest number of times of failure occurrence. Alternatively, preferential order of the failure types may be determined in advance, and the pseudo failure setter 31 may select a failure type among multiple failure types each for which the number of times of generating error data has not reached the corresponding number of times failure occurrence since the pseudo failure mode has been activated in the ascending or the descending order of the above preferential order.

The failure occurrence address data represents the address range of the IO device 5. When the address of data to be obtained in obedience to the obtaining request from the processor 2 is within the range of the failure generating address data corresponding to the failure type to be generated, the pseudo failure setting processor 31a generates error data corresponding to the failure type to be generated. In other words, the failure generating address data is one of the conditions to generate a pseudo failure of the corresponding failure type, and for this purpose, includes the Start Address (SA) and the End Address (EA) that define the conditional range.

In the example FIG. 6, the failure generating address data of “response timeout”, “medium error”, “hardware error”, “interface error” and “correct response” are defined as “SA:0x1000, EA:0x1000”, “SA:0x2000, EA:0x3000”, “SA:0x0, EA:0xffffffff”, “SA:-, EA:-”, and “SA:0x0, EA:0xffffffff”, respectively. As illustrated in FIG. 6, for the failure type “interface error”, for which the number of times of failure occurrence is set to be “0”, that is, for a failure type that does not generate a pseudo failure, a failure generating address data may be left unset.

In the example of FIG. 6, the pseudo failure setter 31 selects the failure type of a failure to be generated and generates error data corresponding to the selected failure type in the following manner.

(a) cases where the failure generating address data is “SA:0x1000, EA:0x1000”, that is, cases where the start address=the end address:

Only when the address of the IO device 5 designated by an obtaining request is “0x1000”, that is, only when the designated address is the same as the start (end) address, the pseudo failure setter 31 generates error data corresponding to the failure type to be generated.

(b) cases where a failure generating address data is “SA:0x2000, EA:0x3000”, that is, cases where an address region is set:

When the address of the IO device 5 designated by an obtaining request is in a region of “0x2000” to “0x3000”, that is, when the designated address is within a set address range, the pseudo failure setter 31 generates error data corresponding to the failure type to be generated.

(c) cases where a failure generating address data is “SA: 0x0 (the leading address of a region storing therein data of the IO device 5), EA:0xffffffff (the final address of a region storing therein data of the IO device 5), that is, cases where entire address of a region storing therein data of the IO device 5 is set:

When the address of the IO device 5 designated by an obtaining request is within the range of “0x0” to “0xffffffff”, that is, when any address of the IO device 5 is designated, the pseudo failure setter 31 generates error data corresponding to the failure type to be generated.

The pseudo failure setting processor 31a specifies the failure generating address data including an address of data to be obtained in obedience to an obtaining request from the processor 2 on the basis of the above failure setting data, and selects a failure type corresponding to the failure generating address data that includes the address to be obtained.

Here, assuming that the address of the IO device 5 designated by an obtaining request is “0x2000”, one of “medium error”, “hardware error”, and “correct response” is selected as a failure type to be generated in the example of FIG. 6. This means that, in the example of FIG. 6, the pseudo failure setting processor 31a is allowed to select “medium error” specified by a narrow range of the failure generating address data as a failure type to be generated.

The selection is not limited to the above, and alternatively, when the address of the IO device 5 designated by an obtaining request is included in multiple ranges of the failure generating address data in the failure setting data, a failure type specified by a wide range of the failure address generating data may be selected or a failure type for which the number of times of failure occurrence is set to be small or large may be selected. Further alternatively, a preferential order may be set for the failure types in the failure setting data in advance, and the failure type to be generated may be selected from multiple failure types including the address of the IO device 5 in the ascending or the descending order of the above preferential order.

In the cases where the entire address of the IO device 5 is set to be the failure generating address data as the example of “hardware error” or “correct response” in FIG. 6, the failure generating address data may not be set. For this purpose, the pseudo failure setter 31 is preferably configured to recognize, if the number of times of failure occurring of the failure type to be generated is set to be one or more and also if the failure generating address data is not set, that the failure generating address data is the entire address of the IO device 5.

As the above, upon receipt of a pseudo failure mode request from the external host device 6, the pseudo failure setting processor 31a sets parameters of the above failure setting data included in the received request in the holder 32. After that, upon receipt of an obtaining request from the processor 2 under a state where the pseudo failure mode is active, the pseudo failure setting processor 31a selects a failure type to be generated on the basis of the number of times of failure occurrence and/or the failure generating address data among the parameters set in the failure setting data.

The manner of selecting a failure type to be generated which selecting is to be made by the pseudo failure setting processor 31a is not limited to the above. Alternatively, the external host device 6 may notify the pseudo failure setter 31 of the failure type to be generated before the processor 2 issues an obtaining request. In this case, the pseudo failure setting processor 31a may select the notified failure type as the failure type to be generated regardless of the parameter of the failure setting data, that is the conditions for selecting the error data.

(1-3-2) Example of Operation of the Error Detector:

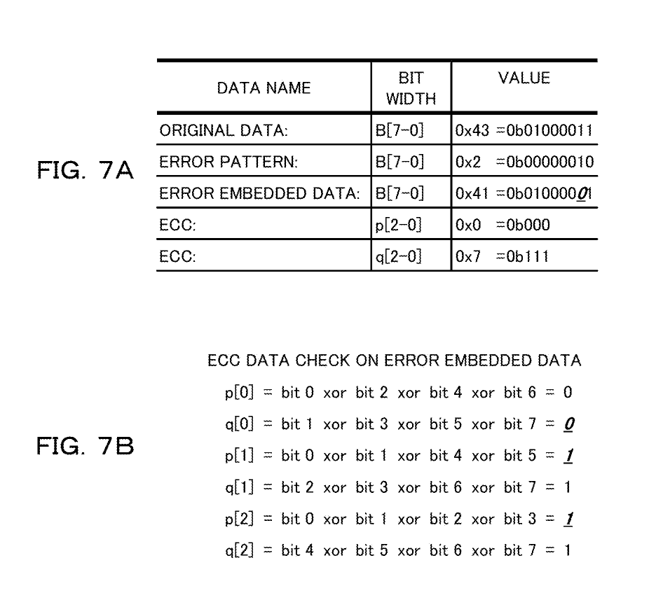

Next, description will now be made in relation to an example of detection of the error bit position by the error detector 35a with reference to FIG. 7.

FIG. 7 is a diagram illustrating an example of detection of the error bit position by the error detector 35a: FIG. 7A is a diagram illustrating an example of data to be processed by the error detector 35a; and FIG. 7B is a diagram denoting the result of ECC data check on error embedded data, the check being made by the error detector 35a.

The following description assumes that the block sizes of the buffer 33b and the error data generator 31c are both eight bits and 8 bit-data is input into the error detector 35a, which carries out data consistency check using an ECC.

As illustrated in FIG. 7A, the following description assumes that the original data is “0x43”=“0b01000011” and the generated error pattern is “0x2”=“0b00000010”.

The values of “p[2-0]” and “q[2-0]”, which are the bit strings of the ECC data, are calculated using the original data in advance when the original data is stored in the IO device 5. For example, as depicted in FIG. 7A, the values 0x0”=“0b000” and “0x7”=“0b111” are calculated beforehand for the bit strings p[2-0] and q[2-0], respectively. The values of “p[2-0]” and “q[2-0]” are calculated by performing an bitwise exclusive disjunction on values at a predetermined bit position, following an expression depicted in, for example, FIG. 7B.

As illustrated in FIG. 7A, when the error setter 34 sets an error pattern “0x2”=“0b00000010” for the original data “0x43”=“0b01000011”, the error embedded data that is to be input into the error detector 35a is “0x41”=“0b01000001”.

The error detector 35a carries out ECC data check on this error embedded data. The result of the ECC data check is denoted in FIG. 7B.

The error detector 35a compares the values “p[2-0]” and “q[2-0]” of the ECC data calculated in advance as denoted in FIG. 7A and the respective results of ECC data check, and as denoted in FIG. 7B, detects that the values q[0], p[1], and p[2] are different from the respective corresponding values of ECC data denoted in FIG. 7A, that is, detects errors in the data.

As an example of a method of detecting the error bit position using an ECC, the error detector 35a sorts the values q[0], p[1], and p[2] detected to be errors from upper bit to arrange, in sequence, p[2], p[1], and q[0], and then substitutes respectively “0” and “1” for p[*] and q[*] to obtain the position “0b001” of the error bit. Namely, the value “0b001” represents the error bit position and the error detector 35a obtains bit “1” for the detected error bit position.

As the above, the error detector 35a checks the data consistency using an ECC, and in the event of detecting the presence of an error, further calculates the error bit position.

When an error as denoted in FIG. 7B is detected in the data input into the error detector 35a under a state where error data is not generated, in other words, under a state where a failure response is not generated, the error corrector 35c inverts the bit value in the original data at a position corresponding to the detected error bit position and thereby the error in the original data is corrected. After that, the error corrector 35c forwards the corrected original data to the processor 2.

As detailed above, the controller 3 of the first embodiment embeds an error, i.e., a failure generating code, into the original data by using error detecting and correcting functions with an ECC, which are used in practical operation, so that the framework to generate a pseudo failure can be easily achieved. Namely, a reproduction test can be easily carried out simply by using the information processing apparatus 1 for practical operation, which means that the controller 3 can eliminate an additional function for analyzing a failure generating code embedded in the original data.

When a pseudo failure is to be generated, the controller 3 of the first embodiment embeds an error into the original data and does not correct an error in the data. On the other hand, when an error occurs in the original data, the controller 3 corrects the error in the data. Thereby, it is also possible to minimize the overhead for data correction.

Since the controller 3 of the first embodiment sets an error that is correctable by an ECC, there is no need to prepare special data to generate a pseudo failure. Furthermore, the data to be forwarded to the processor 2 is the same in size and content as the original data, a reproduction test along the practical operation can be carried out.

Since the processor 2 can carry out a reproduction test in the controller 3 of the first embodiment using the same data pattern as that is used in the practical operation, an accurate reproduction test can be carried out under a state close to the environment of normal operation.

### (1-4) Example of Detailed Operation of the Controller

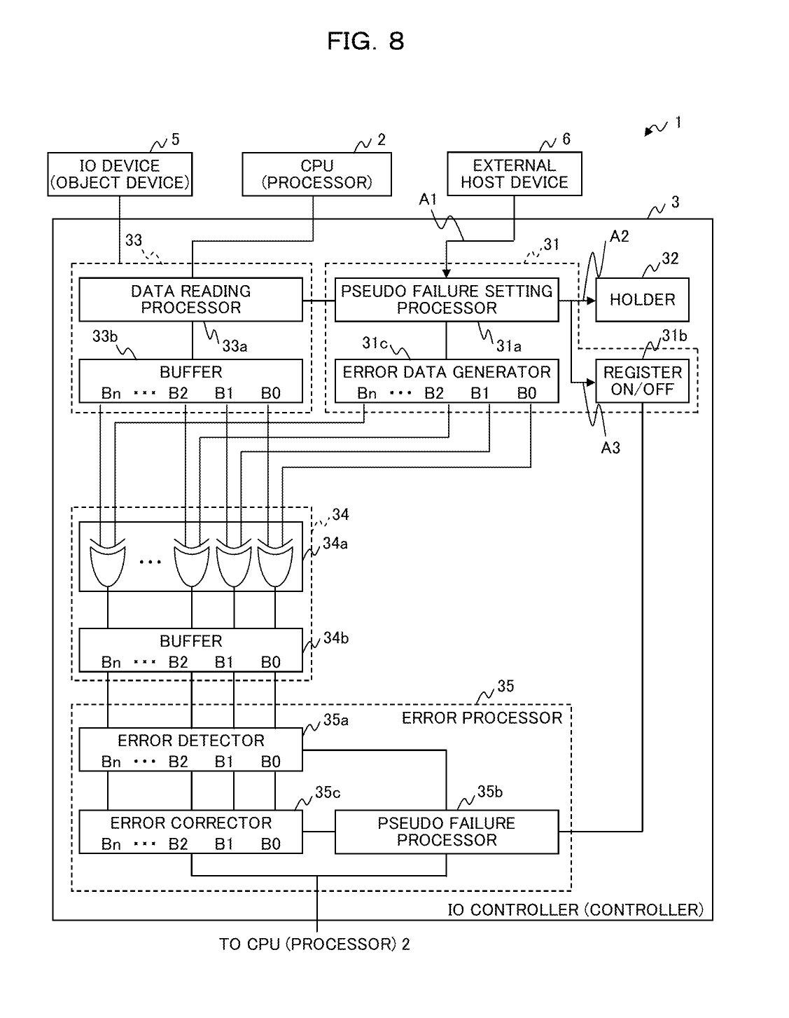

Next, description will now be made in relation to a detailed operation of the controller 3 in the information processing apparatus 1 according to the first embodiment with reference to FIGS. 8-10.

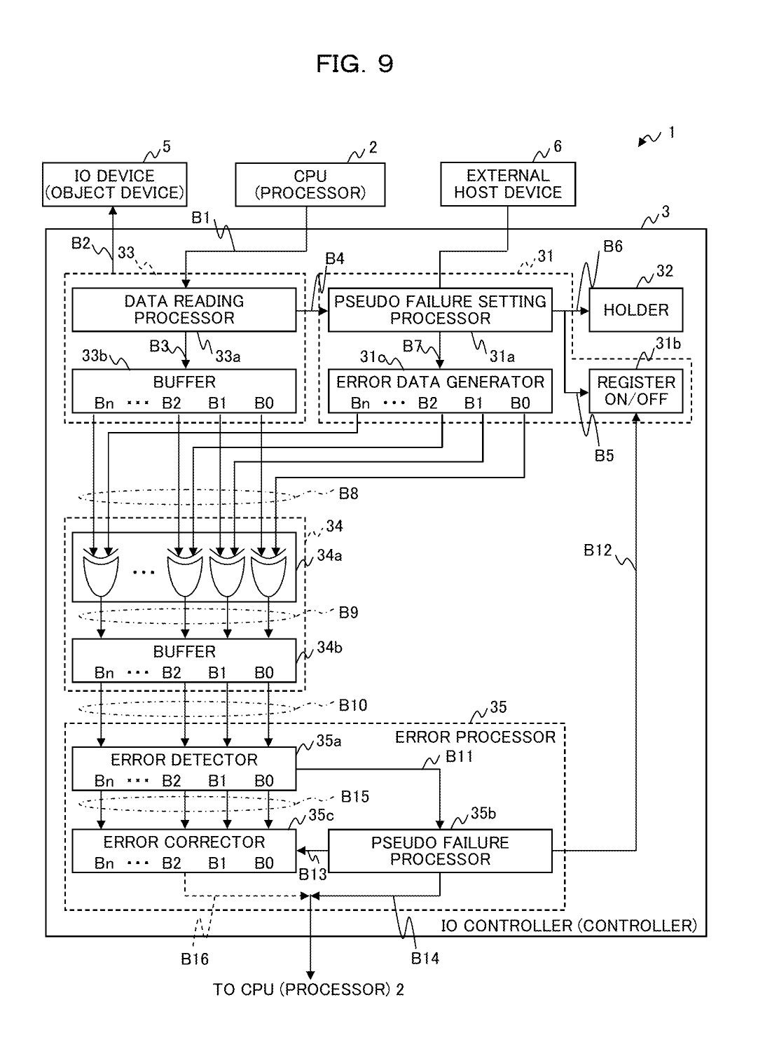

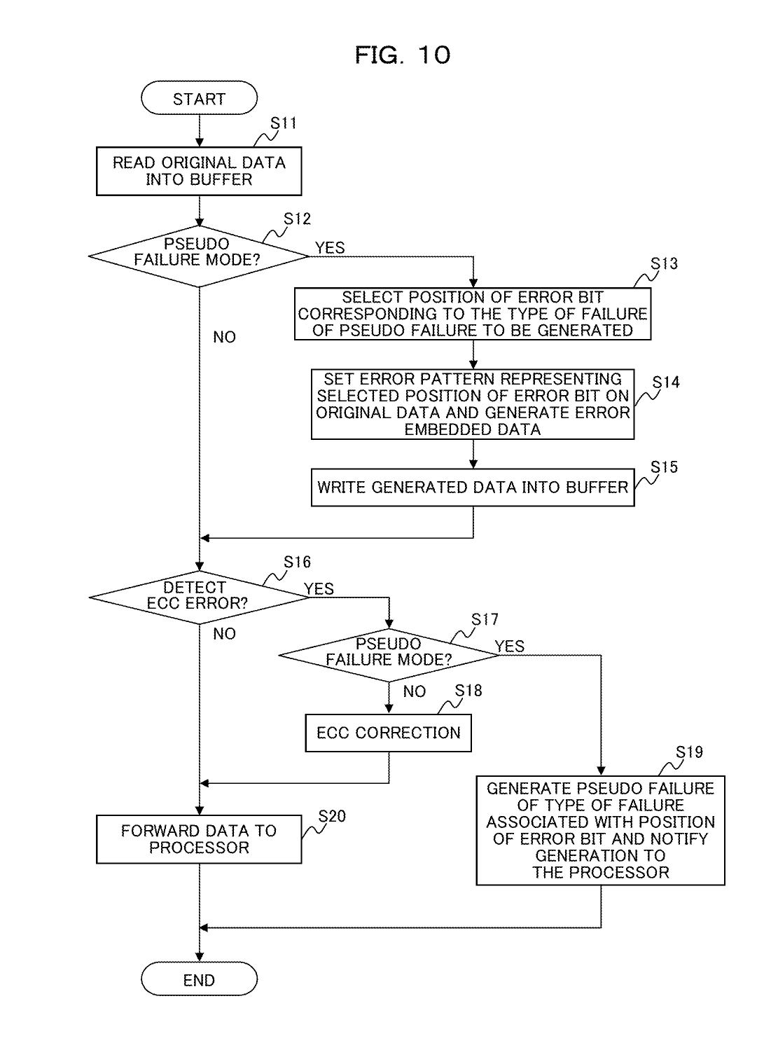

FIG. 8 is a diagram illustrating an example of detailed operation of setting a pseudo failure by the controller 3; FIG. 9 is a diagram illustrating an example of generating a pseudo failure in the controller 3 of the first embodiment; and FIG. 10 is a flow diagram illustrating a detailed succession of procedural steps of generating a pseudo failure in the controller 3.

As illustrated in FIG. 8, in setting a pseudo failure in the controller 3, upon receipt of a pseudo failure mode request from the external host device 6 (arrow A1 in FIG. 8), the pseudo failure setting processor 31a sets parameters being included in the pseudo failure mode request or being received along with the pseudo failure mode request into the holder 32 (arrow A2).

The pseudo failure setting processor 31a also set the flag of the pseudo failure mode on, the flag being held in the pseudo failure mode setter 31b (arrow A3).

As described above, the pseudo failure setting processor 31a sets the flag of the pseudo failure mode off at least one of the case where the number of times of generating error data corresponding to a failure type to be spuriously generated reaches the corresponding number of times of failure occurrence set in the failure setting data and the case where a pseudo failure mode cancel request is received from the external host device 6.

Next, as illustrated in FIG. 9, in generating a pseudo failure in the controller 3, upon receipt of an obtaining request from the processor 2 (arrow B1 in FIG. 9), the data reader 33a obtains the data (original data) from the IO device 5 (arrow B2) in obedience to the obtaining request and stores the obtained original data into the buffer 33b (arrow B3, step S11 in FIG. 10).

Upon receipt of the obtaining request from the processor 2 as indicated by arrow B1 in FIG. 9, the data reading processor 33a outputs an address of data to be obtained in obedience to the obtaining request to the pseudo failure setting processor 31a (arrow B4).

Upon receipt of the address, the pseudo failure setting processor 31a refers to the pseudo failure mode setter 31b to confirm whether the flag of the pseudo failure mode is on (arrow B5, step S12).

If the flag of the pseudo failure mode is on (Yes route in step S12), the pseudo failure setting processor 31a refers to failure type data held in the holder 32 (arrow B6) and selects the error bit position (ECC error bit format) associated with a pseudo failure to be generated (step S12).

Next, the pseudo failure setting processor 31a instructs the error data generator 31c to invert the bit at the selected error bit position and thereby generates an error pattern (arrow B7).

The buffer 33b outputs the original data to the error setting processor 34a and the error data generator 31c outputs the generated error pattern to the error setting processor 34a (arrow B8).

The error setting processor 34a sets an error based on the error pattern in the original data and thereby generates error embedded data (step S14), which is then output to the buffer 34b (arrow B9, step S15).

In contrast, if the flag of the pseudo failure mode is off (No route in step S12), the pseudo failure setting processor 31a does not carry out any processing and the error setting processor 34a outputs the original data, which has been input from the buffer 33b, to the buffer 34b (arrow B9).

After the buffer 34b outputs the original data or the error embedded data to the error detector 35a (arrow B10), the error detector 35a carries out error check on the input data using, for example, an ECC (step S16).

If the error check does not detect an error (No route in step S16), the error detector 35a forwards the input data to the processor 2 through the error corrector 35c (arrows B15 and B16, step S20).

Conversely, the error detector 35a detects an error (Yes route in step S16), the detected error bit position is output to the pseudo failure processor 35b (arrow B11).

Upon receipt of the error bit position, the pseudo failure processor 35b refers to the pseudo failure mode setter 31b, and confirms whether the flag of the pseudo failure mode is on (arrow B12, step S17).

If the flag of the pseudo failure mode is off (No route in step S17), the pseudo failure processor 35b does not carry out any processing and the error corrector 35c carries out data correction on the data input from the error detector 35a using, for example, an ECC (step S18). The error corrector 35c then forwards the corrected data to the processor 2 (arrow B16, step S20).

On the other hand, if the flag of the pseudo failure mode is on (Yes route in step S17), the pseudo failure processor 35b notifies the error corrector 35c of an output ceasing instruction (arrow B13), so that data outputting to the processor 2 is stopped.

The pseudo failure processor 35b generates a pseudo failure of the failure type corresponding to the error bit position and notifies the processor 2 of a failure response (arrow B14, step S19).

As described above, when the failure type corresponding to the error bit position is “response timeout”, the pseudo failure processor 35b may omit generating a failure response of the failure type and may omit notifying the failure response to the processor 2.

Consequently, the controller 3 depicted in FIG. 4 brings the same effects as those of the controller 3 depicted in FIG. 1.

In the cases where the pseudo failure setter 31 of the first embodiment receives an obtaining request and also data obtained from the IO device 5 in obedience to the obtaining request satisfies the conditions defined by the failure setting data held in the holder 32, the pseudo failure setter 31 generates error data corresponding to the failure type to be spuriously generated and outputs the generated error data to the error setter 34. The conditions of the failure setting data are notified to the pseudo failure setter 31 by the external host device 6.

Notifying an arbitrary condition by the external host device 6 or issuing an obtaining request to satisfy the conditions in the failure setting data by the external host device 6 in cooperation with the processor 2 makes the processor 2 possible to obtain a desired failure response from the controller 3, so that a reproduction test can be easily carried out on the information processing apparatus 1 used for practical operation. The controller 3 selects a desired failure type among multiple failure types and generates a pseudo failure corresponding to the selected failure type on the basis of the conditions notified by the external host device 6 and the obtaining request issued by the processor 2.

When the address of data to be obtained in obedience to an obtaining request is within a range indicated by the failure generating address data, the pseudo failure setter 31 selects the failure type associated with the failure generating address data including the address of data to be obtained as the failure type to be generated.

Accordingly, detailed condition can be set for the selection of the failure type to be generated, which can enhance accuracy in a test. Since the range of the address of the IO device 5 that is to be used for generating a pseudo failure, setting the range of address for a pseudo failure to be different from the range of address of the IO device 5 makes it possible to abate influence on practical operation when a pseudo failure is to be generated.

Furthermore, the pseudo failure setter 31 of the first embodiment includes a pseudo failure mode setter 31b, which manages activation and cancellation of the pseudo failure mode according to a pseudo failure mode request and a pseudo failure mode cancel request from the processor 2. This makes it easy to switch the mode of the controller 3 between the normal operation mode and the pseudo failure mode under a state where the firmware used in practical operation is functioning, which means that the time to switch the operation mode of the controller 3 can be reduced. Consequently, influence on the practical operation can be abated.

### (1-5) Modification

In addition to the above first embodiment, the external host device 6 is allowed to notify the controller 3 of parameters, such as a sequence and/or parameter, being included in a pseudo failure mode request or being sent along with a pseudo failure mode request.

A parameter of sequence (Seq) is a failure generating sequence data indicating the sequence of multiple failure types for which failure responses are to be indicated. Namely, if the holder 32 holds a sequence, the pseudo failure setting processor 31a can generate multiple failure types of pseudo failures in combination of each other in a predetermined order.

The sequence assigns the numbers of the error bits in the order of generating pseudo failure, for example, from lower bits.

Each number of the error bit may be the error bit position corresponding to a failure type or an ID corresponding to a failure type. In either case, the numbers of the error bits set in the sequence preferably univocally corresponds to failure types.

When the error bit positions represent the numbers of the error bits and each number of the error bit is assigned in units of four bits, the sequence is set to, for example, “0x302”=“0b001100000010”. In this case, as illustrated in FIGS. 5 and 6, the controller 3 generates a failure response to the “medium error” corresponding to the error bit position “bit 2” three times as represented by the number of times of failure occurrence, then the controller 3 generates a failure response to the “correct response” corresponding to the error bit position “bit 0” ten times, and finally, generates a failure response to the “hardware error” corresponding to the error bit position “bit 3” five times.

Upon receipt of an obtaining request under a state where the flag of pseudo failure is on, the pseudo failure setting processor 31a of this modification selects a failure type to be generated with reference to the sequence. The pseudo failure setting processor 31a then determines whether the data to be obtained from the IO device 5 satisfies the conditions for the selected failure type in the failure setting data, that is, the conditions being the number of times of failure occurrence and the failure generating address data.

If the data satisfies the conditions, the pseudo failure setting processor 31a generates error data corresponding to the selected failure type. On the other hand, if the data does not satisfy the conditions, the pseudo failure setting processor 31a does not generate error data even when the data satisfies the conditions for another failure type in the failure setting data.

Using the failure generating order data, the controller 3 of the first embodiment is capable of generating multiple failure types of pseudo failure in combination of each other in a predetermined order. Namely, the processor 2 can receive failure responses in a predetermined order by outputting the failure generating order data from the external host device 6 to the controller 3. Accordingly, the processor 2 is capable of easily carrying out a regeneration test under the presence of multiple failures.

The cycle number is repeating data that sets the number of times of generating of a series of operation defined in the sequence. When the holder 32 holds the sequence and the cycle number, the pseudo failure setting processor 31a repeats generating of multiple failure types of pseudo failure in combination with each other in a predetermined order the number of times defined in the cycle number.

For example, when “0x302”=“0b001100000010” is set in the sequence as the above and the number “2” is set in the cycle number, “medium error” is generated three times; “correct response” is generated ten times; “hardware error” is generated five times; “medium error” is generated three times; “correct response” is generated ten times; and “hardware error” is generated five times.

As the above, setting the cycle number by the external host device 6 allows the processor 2 to carry out, when predetermined failure types are repeatedly performed in a predetermined order, a reproduction test with ease.

### (2) Others

The preferable embodiment and modification thereof are described as the above. The present invention should by no means be limited to the above embodiment and modification, and various changes and modifications can be suggested without departing from the gist of the present invention.

For example, the first embodiment and the modification assume that the controller 3 is an IO controller and the object device 5 is an IO device, but the present invention is not limited to those. Since the controller 3 uses error detecting and correcting functions of the ECC, which has already been installed in the controller 3, as the error detector 35a and the error corrector 35c, the object device 5 is not limited to an IO device such as a HDD and may be any device as far as the device can use the error detecting and correcting functions of the ECC as the memory 4. In the cases where the memory 4 is used as the object device 5, the functions of the controller 3 may be installed in, for example, a memory controller.

In the above first embodiment and the modification, the processor 2 serving as a host device outputs an obtaining request to the controller 3 while the external host device 6 in charge of managing the information processing apparatus 1 outputs a pseudo failure mode request, pseudo failure mode cancel request, and various pieces of data to be held in the holder 32 to the controller 3. However, the present invention is not limited to this. Alternatively, these requests and data pieces may be output from a device different from the processor 2 to the controller 3, serving as an IO controller, through an interface and a network connected to the controller 3. This means that a reproduction test in the information processing apparatus 1 may be carried out by a host device different from the processor 2 and by the external host device 6.

In the above embodiment, the external host device 6 notifies the controller 3 of failure type data and the parameters of failure setting data in the form of being included in a pseudo failure mode request or being set along with a pseudo failure mode request. Similarly in the above modification, the external host device 6 notifies the controller 3 of the parameters of the failure generating order data and the repeating data, the parameters being included in the pseudo failure mode request or being sent along with the pseudo failure mode request. However, the present invention should by no means be limited to this. Alternatively, the external host device 6 may notify these parameters before the failure mode request is issued to the controller 3.

The program (pseudo failure generating program) to achieve the functions of the pseudo failure setting processor 31a, the data reading processor 33a, the error setting processor 34a, the error processor 35, the error detector 35a, the pseudo failure processor 35b, and the error corrector 35c is provided in the form of being stored in a computer-readable recording medium such as a flexible disk, a CD (e.g., CD-ROM, CD-R, and CD-R), a DVD (e.g., DVD-ROM, DVD-RAM, DVD-R, DVD+R, DVD-RW, DVD+RW, and HD DVD), a Blu-ray disk, a magnetic disk, an optical disk, an optic-magnetic disk. The computer reads the program from the recording medium and stores the program into an internal or external memory for future use. Alternatively, the program may be stored in a memory device (recording medium) such as a magnetic disk, an optical disk, and an optical-magnetic disk and may be provided to the computer from the memory device through a communication line.

In order to achieve the functions of the pseudo failure setting processor 31a, the data reading processor 33a, the error setting processor 34a, the error processor 35, the error detector 35a, the pseudo failure processor 35b, and the a error corrector 35c, the microprocessor (i.e., the processor of the controller 3 in the first embodiment) executes the program stored in the internal memory device (i.e., the memory in the controller 3 in the first embodiment). For this purpose, the computer may read the program stored in a recording medium and execute the program.

Here, a computer is a concept of a combination of hardware and an OS and means hardware which operates under control of the OS. Otherwise, if an application program operates hardware independently of an OS, the hardware corresponds to the computer. Hardware includes at least a microprocessor such as a CPU and means to read a computer program recorded in a recording medium. In the above first embodiment, the controller 3 functions as the computer.

The technique disclosed herein can abate influence on practical operation when a pseudo failure is generated for a test using an information processing apparatus being practically used. Advantageously, it is possible to enhance the accuracy of the test using an information processing apparatus being practically used. Furthermore, the test can be easily accomplished using an information processing apparatus being practically used.

All examples and conditional language provided herein are intended for pedagogical purposes to aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising a processor and a controller that obtains data from an object device in obedience to an obtaining request from the processor,
the controller comprising:
an error setter that sets, when a pseudo failure mode that spuriously generates a failure is active, an error associated with a failure type of a pseudo failure to be generated in the data obtained from the object device in obedience to the obtaining request; and
an error processor that notifies, when detecting an error in the data under a state where the pseudo failure mode is active, the processor of the failure response corresponding to the failure type associated with the detected error.

2. The information processing apparatus according to claim 1, the error processor comprising:
an error corrector that corrects, when the detected error is correctable, the correctable error; and
a pseudo failure processor that prevents, when the error is detected in the data under a state where the pseudo failure mode is active, the error corrector from correcting the error detected in the data, and notifies the processor of a failure response corresponding to the failure type associated with the detected error.

3. The information processing apparatus according to claim 1, the error processor further comprising an error detector that performs error check on the data to detect whether the data has an error and to further detect, when an error is detected, the position of an error bit related to the detected error,
the error processor notifying, when the error check performed by the error detector detects the position of the error bit through the error check under a state where the pseudo failure mode is active, the processor of a failure response corresponding to the failure type associated with the detected position of the error bit.

4. The information processing apparatus according to claim 3, wherein the error detector detects the position of the error bit in the data using an Error Correcting Code (ECC).

5. The information processing apparatus according to claim 1, further comprising:
a holder that holds failure setting data including a condition to generate error data indicating the position of an error bit associated with the failure type; and
a pseudo failure setter that generates, when the controller receives the obtaining request from the processor and when the data obtained from the object device in obedience to the obtaining request satisfies the condition included in the failure setting data held in the holder, error data corresponding to the failure type of the pseudo failure to be spuriously generated and outputs the generated error data to the error setter,
the error setter setting the error associated with the failure type of the pseudo failure to be generated in the data obtained from the object device in obedience to the obtaining request, the error being based on the error data input from the pseudo failure setter.

6. The information processing apparatus according to claim 5, wherein:
the failure setting data includes failure generating address data associated with the failure type;
the pseudo failure setter selects, when the address of the data obtained in obedience to the obtaining request is included in a region indicated by the failure generating address data, a failure type associated with the failure generating address data including the address of the data as the failure type of the pseudo failure to be generated.

7. The information processing apparatus according to claim 5, further comprising a setter that issues a pseudo failure mode request to activate the pseudo failure mode to the pseudo failure setter,
the pseudo failure setter further comprising a pseudo failure mode setter that activates, upon receipt of the pseudo failure mode request from the setter, the pseudo failure mode,
the pseudo failure setter generating, when the controller receives the obtaining request and when the pseudo failure mode is active, error data corresponding to the failure type and outputs the generated error data to the error setter.

8. The information processing apparatus according to claim 7, wherein, at least one of when the failure setting data includes the number of times of failure occurrence associated with the failure type and the number of times of generating error data corresponding to the failure type of the pseudo failure to be generated reaches the number of times of failure occurrence and when the pseudo failure mode setter receives a pseudo failure mode cancel request to cancel the pseudo failure mode from the setter, the pseudo failure mode setter cancels the pseudo failure mode.

9. The information processing apparatus according to claim 7, wherein:
the setter outputs the failure setting data to the pseudo failure setter; and
the pseudo failure setter sets, upon receipt of the failure setting data from the setter, the input failure setting data into the holder.

10. The information processing apparatus according to claim 5, wherein:
the holder further holds failure generating order data indicating an order of generating failure responses related to a plurality of the failure types; and
the pseudo failure setter
selects, when the controller receives the obtaining request, the failure type of the pseudo failure to be generated, based on the failure generating order data, and
generates, when the data obtained from the object device in obedience to the obtaining request satisfies the condition related to the selected failure type in the failure setting data held in the holder, error data corresponding to the selected failure type, and outputs the generated error data to the error setter.

11. The information processing apparatus according to claim 1, wherein, when the failure type associated with the detected error is a failure a response of which is not able to be notified to the processor, the error processor prevents notification of a failure response related to the failure type to the processor.

12. A method for generating a pseudo failure in an information processing apparatus comprising a processor and a controller that obtains data from an object device in obedience to an obtaining request from the processor, the method comprising:
at the controller
setting, when a pseudo failure mode that spuriously generates a failure is active, an error associated with a failure type of a pseudo failure to be generated in the data obtained from the object device in obedience to the obtaining request; and
notifying, when detecting an error in the data under a state where the pseudo failure mode is active, the processor of a failure response corresponding to the failure type associated with the detected error.

13. The method according to claim 12, further comprising:
at the controller correcting, when the detected error is correctable, the correctable error; and
preventing, when the error in the data under a state where the pseudo failure mode is active, correction of the error detected in the data, and notifying the processor of the failure response corresponding to the failure type associated with the detected error.

14. The method according to claim 12, further comprising:
performing error check on the data to detect whether the data has an error and to further detect, when an error is detected, the position of an error bit related to the detected error; and
notifying, when the error check detects the position of the error bit under a state where the pseudo failure mode is active, the processor of a failure response corresponding to the failure type associated with the detected position of the error bit.

15. The method according to claim 12, further comprising:
at the controller
generating, when the controller receives the obtaining request from the processor and when the data obtained from the object device in obedience to the obtaining request satisfies a condition to generate error data indicating the position of an error bit associated with the failure type, the condition being included in failure setting data stored in a holder, error data corresponding to the failure type of the pseudo failure to be spuriously generated; and
setting the error associated with the failure type of the pseudo failure to be generated in the data based on the generated error data.

16. The method according to claim 15, wherein:
the failure setting data includes failure generating address data associated with the failure type; and
the method further comprising:
at the controller
selecting, when the address of the data obtained in obedience to the obtaining request is included in a region indicated by the failure generating address data, a failure type associated with the failure generating address data including the address of the data as the failure type of the pseudo failure to be generated.

17. The method according to claim 15, further comprising:
at the controller,
activating, upon receipt of a pseudo failure mode request to activate a pseudo failure mode from a setter, the pseudo failure mode;
generating, upon receipt of the obtaining request under a state where the pseudo failure mode is active, error data corresponding to the failure type; and
setting an error associated with the failure type of the pseudo failure to be generated in the data, the error being based on the generated error data.

18. The method according to claim 17, further comprising:
at least one of when the failure setting data includes the number of times of failure occurrence associated with the failure type and the number of times of generating error data corresponding to the failure type of the pseudo failure to be generated reaches the number of times of failure occurrence, and when a pseudo failure mode cancel request to cancel the pseudo failure mode is input from the setter,
cancelling the pseudo failure mode.
